(19) United States
(12) Patent Application Publication
(10) Pub. No.: US 2007/0296172 A1
(43) Pub. Date: Dec. 27, 2007

(54) Wedge-Displaceable Bearing for a Motor Vehicle Steering Gear

(75) Inventor: Friedhelm Gunther, Dortmund (DE)

Correspondence Address: KREMBLAS, FOSTER, PHILLIPS & POLLICK, 7632 SLATE RIDGE BOULEVARD, REYNOLDSBURG, OH, 43068, US

(73) Assignee: Schmitter Chassis GmbH , a German Company with Limited Liability

(21) Appl. No.: 10/585,679

(22) PCT Filed: Jan. 26, 2005
(86) PCT No.: PCT/EP05/00743

§ 371 Date: May 16, 2007

(30) Foreign Application Priority Data
Jan. 26, 2004 (DE) 10 2004 003 992.5
Feb. 24, 2004 (DE) 10 2004 009 451.9

(51) Int. Cl. B62D 3/12; F16H 55/26

(52) U.S. Cl. 280/93.515; 280/93.514

(57) ABSTRACT

A bearing module for a motor vehicle steering gear, comprising a steering rack (9) and a driving pinion (10) engaging therewith. The bearing module comprises at least one pressure part (3; 13, 30) exhibiting recess concavity, whose concave wall surrounds a guide through-passage (14) for axial guidance of the steering rack (9), and radial forces emitted from the wall are generated by means of at least one translatory displaceable wedge device (3c, 13; 30a; 31a) for pressing the steering rack (9), which is received in the guide through-passage (14), onto the drive pinion (10) engaging therein. The wedge device or wedge devices (3c, 13; 30a; 31a) are displaceably (14) guided in one direction extending axially or parallel to the axis in relation to the guide through-passage (14) for the steering rod (9).

The invention relates to a bearing module for a motor vehicle steering gear having a rack and a driving pinion in mesh therewith according to the preamble of claim 1. Further, the invention relates to a motor vehicle steering gear in which, within a gear housing, a rack is in mesh with a driving pinion and a corresponding bearing module is mounted according to the preamble of claim 30. Further, the invention relates to a motor vehicle steering gear with a rack in mesh with a driving pinion within a gear housing, according to the preamble of claim 33. Further, the invention relates to a pressure shell, which is suitable as a guide pressure part for such a bearing module or as a pressure member for such a steering gear, according to the preamble of claim 49. Further, the invention relates to a housing suitable for such a steering gear according to claims 54 and 57.

A generic rack and pinion steering system is described in Patent Abstracts of Japan JP 58 020 561 A. The adjustability of the engagement play between the rack and pinion is to be simplified by means of a wedge mechanism. On of the two slopes of the wedge mechanism is formed by a slide block, which is slidable in translation via a spring-loaded screw. Via the wedge mechanism, the translational displacement of the slide block is converted into a radial pressure force on the rack. The displacement of the wedge-shaped slide block is effected by a set screw penetrating the steering gear housing laterally, transverse to the longitudinal axial direction, also in this transverse direction. From this arises the need with this steering gear housing to have to meet additional structural and engineering precautions such as a lateral transverse opening with extra projection etc.

Automatic making up or adjustment for wear is made possible by the rack and pinion arrangement for motor vehicle steerings described in U.S. Pat. No. 3,820,415. For this, however, use is made of an eccentric bearing in the form of a curved wedge segment which is to be rotated and which slides in a recess in the pinion housing and is turned in such a manner that it pushes the rack towards the pinion. The curved part has only the degree of freedom of rotating in the recess, but is held axially rigid against axial displacement by an extra circumferential ridge provided on the convex part of the wedge. By means of a spring, the wedge is so biased in the circumferential direction that it can be automatically further rotated towards the narrow end of the gap. Thus the rack is to be pushed into fully meshing engagement with the pinion in the direction of the desired adjustment for wear.

According to WO-A-2004/067 357, for pressing the rack and pinion on to one another, likewise an eccentric bearing module is used, which is preassembled from a kit as an independent installation unit (bearing module) before actual assembly in the rack housing. However, due to the type of construction the need for additional, manual fine adjustment is not provided. A rotational bias of the eccentric bearing bore for the purpose of making up for wear is not provided.

The object of the invention is so to develop the pressure member for the driving pinion-rack engagement in a steering gear that whilst retaining the option of comfortable subsequent fine adjustment of the pressure member, the steering gear housing is simplified in shape and manufacturing. To achieve this, the bearing module indicated in claim 1, the steering gear indicated in claims 28 and 31, the pressure shell indicated in claim 45 as a guide pressure part for a bearing module or as a pressure member for a steering gear, and the specific housing indicated in claim 48 are proposed. Optional, further features of the invention will appear wholly or in part from the dependent claims.

With the invention, the advantage is gained of being able to undertake fine adjustment of the rack play in the axial and axially parallel direction by means of an elongate tool from the end face of the tubular gear housing. Since the end face of the elongate, generally tubular gear housing is in any case always open, the need according to the prior art does not arise, of forming a separate housing part in order to be able to reach the pressure member and its wedge-shaped adjustment mechanism radially or from the side transverse to the longitudinal direction. Since with the invention specific access ways to the pressure member transverse to the rack longitudinal axis no longer have to be formed, according to the invention a considerable simplification and economy of the gear housing can be achieved.

According to an embodiment of the invention, one or more wedge devices are disposed inside the receiving concavity of the pressure member. Since the pressure member is thus no longer upstream of the radial forces of the pressure member generated in a wedge-like manner in the direction of the rack, a more direct action of the one or more wedge devices on the play between rack and driving pinion can be achieved. This aspect is further enhanced by an embodiment of the invention according to which the one or more wedge devices abut or are supported directly on the pressure member wall defining the concavity. In order to ensure sufficiently effective guiding for the reciprocating motion of the rack in this association, it is advantageous to connect downstream of the chain “pressure member-inner wall, wedge device(s) . . . ” as a further member one or more guide pressure parts defining the guide passage proper. Particularly advantageously, the one or more wedge devices would then be disposed between the pressure member and the one or more guide pressure parts. In an extension of this notion, a particularly advantageous embodiment of the invention is achieved if one of the two mutually abutting slopes of a wedge device are formed on one side on a pressure member inner wall and on the other side on the opposite wall of the respective guide pressure part. Thus the dynamic effect chain on both components “pressure member” and “guide pressure part” is reduced, which produces a minimisation of the necessary number of structural components.

A more efficient way in terms of manufacturing technology of providing the pressure member inner wall with the only or the respective first slope of the wedge devices to be formed in common with the guide pressure parts, consists in embossing recesses in the pressure member outer casing or on the pressure member exterior, the recesses having complementary forms to the outlines of the slopes.

Assembly is simplified if according to an embodiment of the invention, on the pressure member inner wall or in the rack guide passage one or more support means are provided, whereby the guide pressure part(s) can be guided to the wedge region or to the rack/pinion mesh region.

In order to deflect power from the axial into the radial direction on to the rack, according to one embodiment of the invention, alternatively or in addition to the wedge device mentioned above, which is characterised by the pressure member inner wall and the integral slopes of the guide pressure part outer wall, at least one separately formed wedge member can be provided with two wedge flanks extending at an acute angle. In a further advantageous embodiment, one wedge flank extends axially or axially parallel, whilst the other wedge flank forms one of the two slopes of a wedge device and is allocated to its second slope for abutment. The latter can be formed on the outer face, opposite the wedge member, of the guide pressure part or opposite inner face of the pressure member complementarily to the first slope. Thus, advantageously, a particularly smoothly adjustable wedge device is achieved, because the separately formed wedge member can be a loose, lightweight, preferably plastics part. To manufacture the loose wedge member, plastics injection moulding is particularly suitable. This also applies to the guide pressure parts, particularly if this has a type of bush shape.

The position accuracy and operating reliability can be increased with one embodiment according to which the wedge member is provided with one or more stops, which project transversely and are allocated to the pressure member and/or the guide part for abutment or support in a circumferential direction concentric to the guide passage. Thus fixing of the wedge member against rotation is achieved.

The handling and/or operating properties of the bearing module can be increased with one embodiment according to which an actuator is provided and is in active connection with one or more wedge devices for their axial or axially parallel displacement. To this end, it is advantageous so to form and mount the actuator that it may be movably guided and/or locked or fixed relative to the pressure member.

According to one embodiment of the invention, a spring element is disposed in the axial and/or axially parallel direction for biasing a wedge device. An advantage thus gained is that controlled axial play between the actuator and the wedge device can be formed, which is under the restoring force of the spring element. Thus the pressure member and/or the guide pressure part can be moved axially to and fro somewhat against the force of the spring element. As a further consequence, thus rack play can be set in a controlled manner.

To carry out biasing, one embodiment of the invention consists in supporting the respective spring element against the actuator on the one hand and against one of two slope elements displaceable in opposite directions of a wedge device. This can be effected particularly simply with an annular spring, which is disposed concentrically to the rack guide passage. Alternatively or in addition, the spring element can be incorporated structurally with the only or one of the guide pressure parts, by forming a receiving chamber therein, in which the spring is received. Particularly advantageously, the spring element is so formed that it projects in part or by a section out of the receiving chamber. This gains the advantage that the actuator can act easily on the spring element. Alternatively, the actuator may have a pressure lug for engagement in the receiving chamber and for pressing on to the spring element housed therein. As material for the spring element to be housed in the receiving chamber, elastomer is particularly suitable.

The bearing module must be so mounted in the steering gear housing that the radial pressure forces which may be generated by means of the wedge device(s) is oriented on to the side of the rack which is remote from the rack teeth. To fix a bearing module assembly in position in such a manner with rapid handling, according to one embodiment it is proposed that the outer casing of the pressure member is provided with one or more orientation projections and/or recesses. These are complementary recesses or projections allocated on the inner face of the (hypothetical) steering gear housing and are so positioned in the circumferential direction that upon assembly with the rack and the driving pinion in the steering gear housing, the radial forces emitted from the concave wall of the pressure member inner face are directed on to the rack outer face mentioned.

For easy-to-handle assembly, it is advantageous if within the scope of the invention the pressure member and optionally the guide pressure part(s) disposed concentrically thereto are at least partly formed with an open longitudinal side parallel to the axis of the guide passage. Thus the rack can be inserted in the meshing region with the driving pinion easily within the receiving concavity of the pressure member/guide pressure parts. Particularly advantageously, the longitudinal side edges, which define the longitudinal side opening, are formed so as to extend obliquely like a ramp or slope with respect to the axis or a longitudinal plane of the guide passage or of a hypothetical steering gear housing. Thus upon insertion into the steering gear housing, the driving pinion tube can be so wedged with the oblique longitudinal side edges that the bearing module can no longer rotate in the steering gear housing. To this end, it is advantageous to form the driving pinion tube with edges which project into the housing interior. By this wedging, the assembly composite consisting of the bearing module-driving pinion/rack-mesh and gear housing is made play-free.

In order to achieve as centred a position as possible for the rack in terms of its guide passage in the bearing module or optionally in the steering gear housing, according to the invention it is provided to provide plural wedge devices in any case, which are so arranged relative to one another that the normals to their respectively abutting slopes intersect in the centre of the guide passage (or of a hypothetical steering gear housing) and/or at an angle of less than 180°. Since the radial forces emitted therefrom extend according to the normals, thus a centring, converging action of the radial forces from the wedge devices on to the rack is produced.

In order to effect statically unambiguously determined positioning of the rack in the guide passage and to manage with a minimum of components, it is advantageous with only two wedge devices to generate respectively a radial pressure force on to the rack by the convergence of the normals to the mutually abutting wedge slopes towards the centre of the guide passage of the rack. Thus a type of three-point system is achieved, in which the rack support is unambiguous and is neither underdetermined nor overdetermined.

A motor vehicle steering gear falling within the scope of the general inventive notion, in which the bearing module according to the invention is assembled, is characterised by an actuator so mounted in the bearing module and so formed that it can be actuated by an axially insertable tool. As discussed above, the actuator is so in active connection with the wedge device(s) that these may be displaced axially or axially parallel.

In the following, in order to avoid repetition, the embodiments made previously with respect to the bearing module are referred to accordingly where applicable for this steering gear.

Within the scope of the general invention notion, there is also a motor vehicle steering gear without the bearing module assembled from an independent kit, although use is made accordingly of the principle explained above of the axial or axially parallel displacement of one or more wedge devices. To this end, a pressure member is particularly suitable having the basic form of a partial cylinder open on the longitudinal side or other convex shell, in which case the shell opening or concave partial cylinder side is oriented towards the guide passage for the rack. Such a form is relatively easy and lightweight to manufacture, particularly by means of the plastics injection moulding process, and is quick to assemble in the steering gear housing.

Within the scope of the invention it is advantageous to form the one or more wedge devices with two complementary slopes allocated to one another for abutment and displaceable relative to one another. In this case, in the last alternative of the invention mentioned, an advantageous embodiment is produced without preassembly of an independent bearing module in that the one slope is formed on an outer face or outer casing of the pressure member and the other (counter-)slope is formed on an opposite inner face or an opposite inner casing of the steering gear housing. The advantage thus gained consists in a saving on individual components. The steering gear housing necessary in any case is at the same time exploited, via oblique faces on its inner wall, to contribute to formation of the wedge device.

In the following, in order to avoid repetition, we refer accordingly to the embodiments made in connection with the bearing module above, in so far as these are applicable to the steering gear just discussed.

To increase the operating safety and reliability, it is advantageous to provide the pressure member and/or optionally the bearing module with a locking device, which fixes the same in the axial or axially parallel direction or in its position. In this connection, a particularly advantageous embodiment which saves space and components consists in realising the locking device with a stop block inserted axially in the gear housing and a radial deformation, e.g. bead formation. The stop block advantageously forms a steering stop and also an obstacle to prevent the bearing module or pressure member from slipping out axially.

Within the scope of the general inventive notion is a pressure shell, which may act as a guide pressure part for the abovementioned bearing module or as a pressure member for the abovementioned steering gear. The pressure shell according to the invention is characterised by a realisation with a casing or wall section which is partially cylindrical or open on the longitudinal side or with a wall section curved in another way, in which case a convex outer face and a concave inner face or opening side are produced. A particularly advantageous embodiment consists in making the oblique faces necessary for the abovementioned wedge devices extend obliquely like a ramp to the cylinder longitudinal axis or to another longitudinal direction of the concave opening side. Thus the pressure shell is suitable for forming wedge devices together with opposing counter-slope faces of the pressure member or of the steering gear housing. In the following, in order to avoid repetition, we refer to the comments above on the wedge devices in connection with the bearing module or the steering gear, where these are correspondingly applicable.

Within the scope of the general inventive notion is also a steering gear housing which is characterised by slopes formed on the housing inner face, which extend rising or falling with respect to an axially parallel direction. These housing inner slopes are suitable to form the wedge device adjustable axially or axially parallel together with opposing counter-slopes of a pressure member, of a pressure shell or of another bearing module. In the following, in order to avoid repetition, we refer to the comments above on the wedge devices in connection with the bearing module, the steering gear housing or the pressure shell, where these are correspondingly applicable.

Further details, features (sub-)combinations, advantages and effects on the basis of the invention will appear from the following description of preferred embodiments and from the drawings, which show:

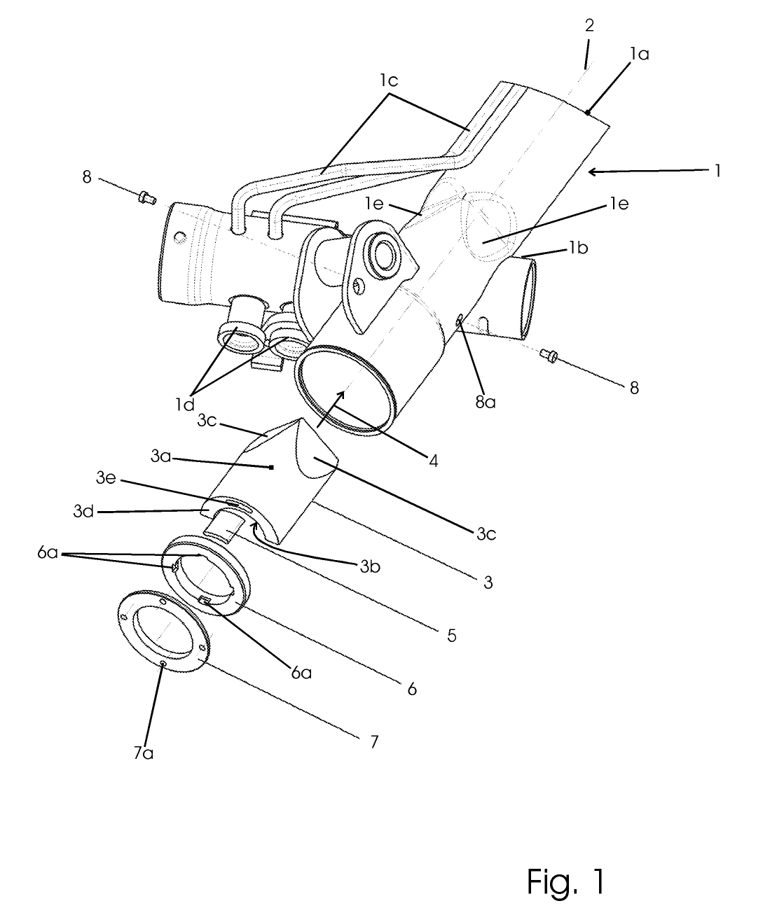

FIG. 1 a first embodiment in an exploded perspective diagram,

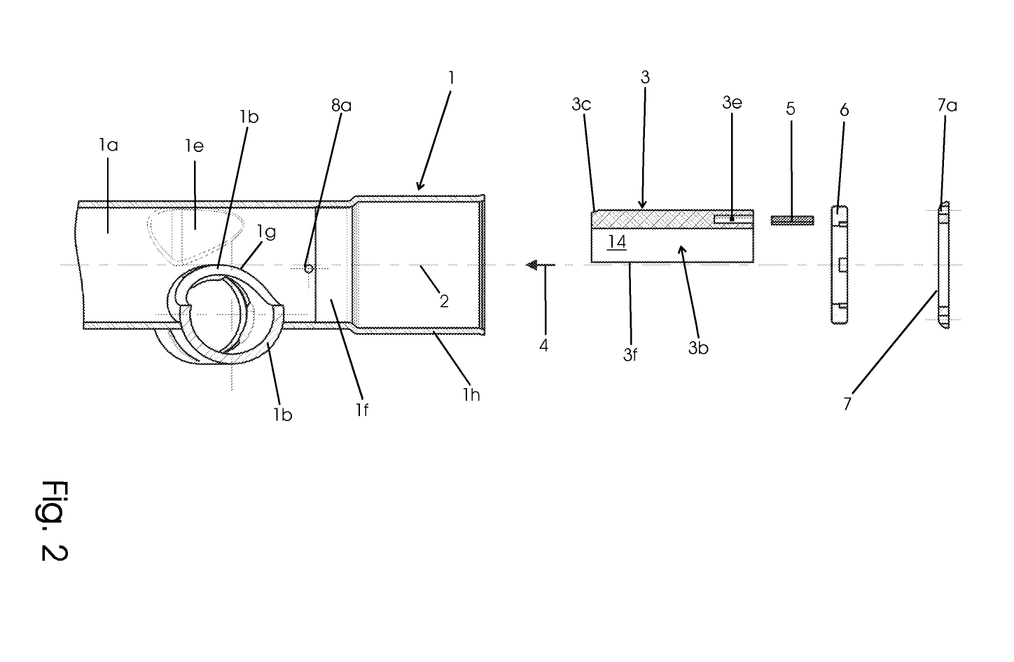

FIG. 2 the exploded diagram of FIG. 1 in a section in a longitudinal section view,

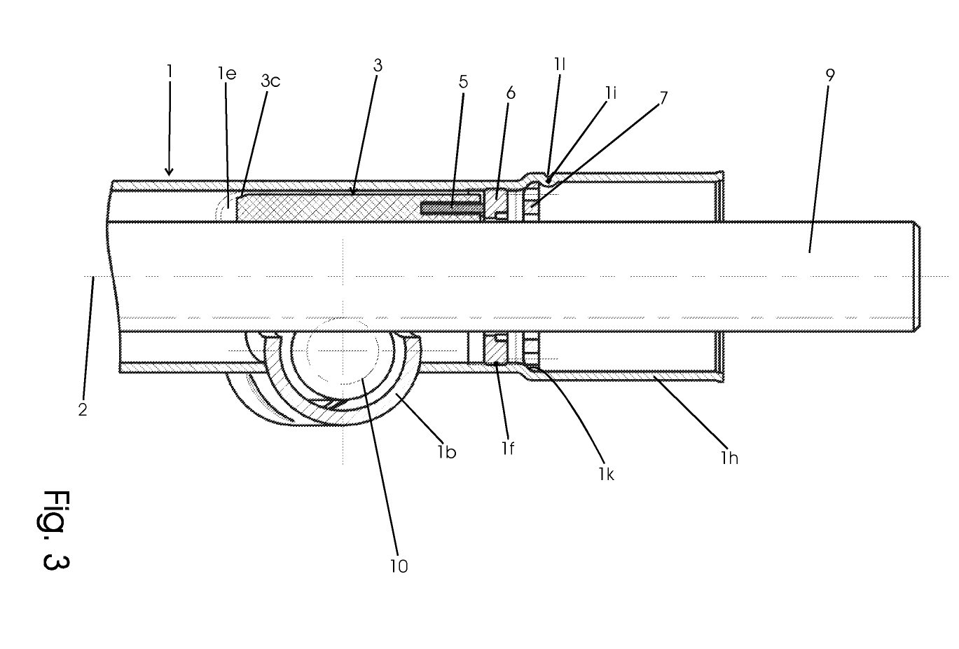

FIG. 3 partly in longitudinal section the parts shown in FIGS. 1 and 2 in the fully assembled state,

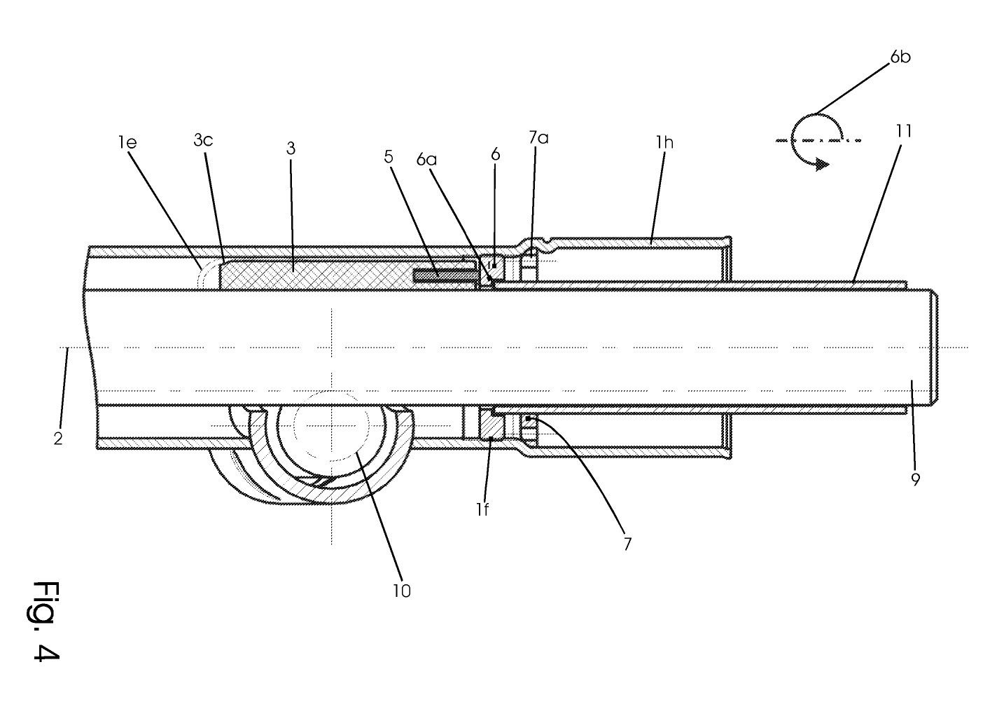

FIG. 4 a longitudinal section view with the insertion of an adjusting tool,

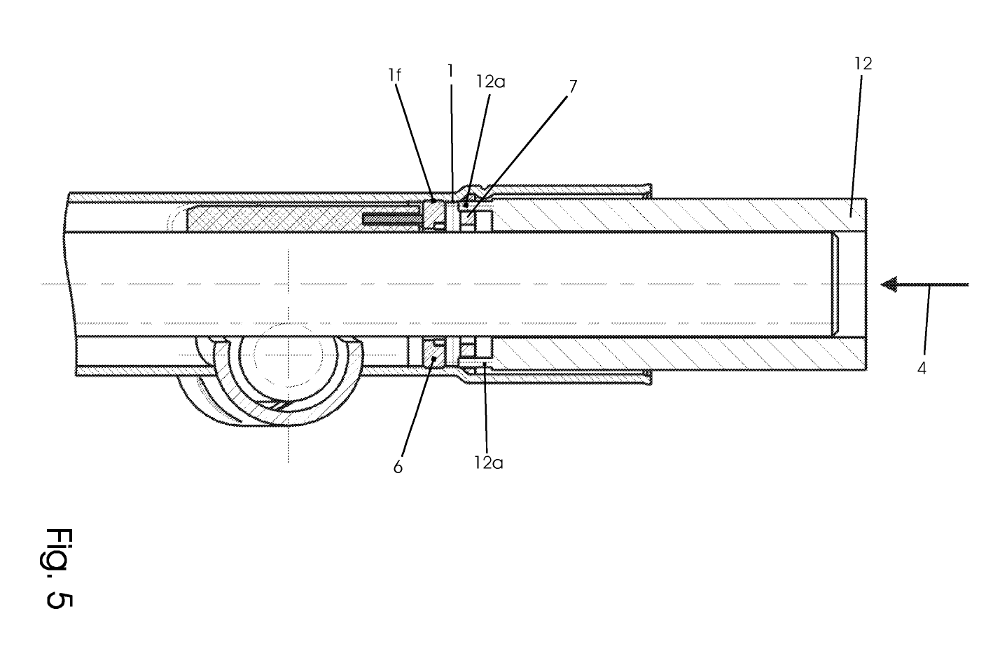

FIG. 5 a longitudinal section view corresponding to FIG. 4, showing the insertion of a caulking tool,

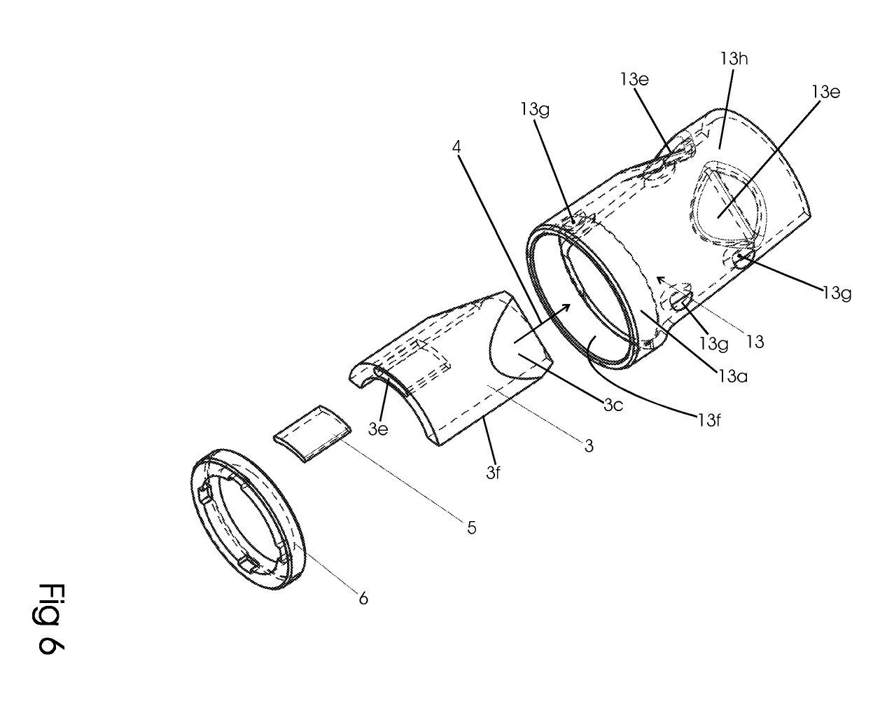

FIG. 6 a second embodiment in an exploded perspective diagram,

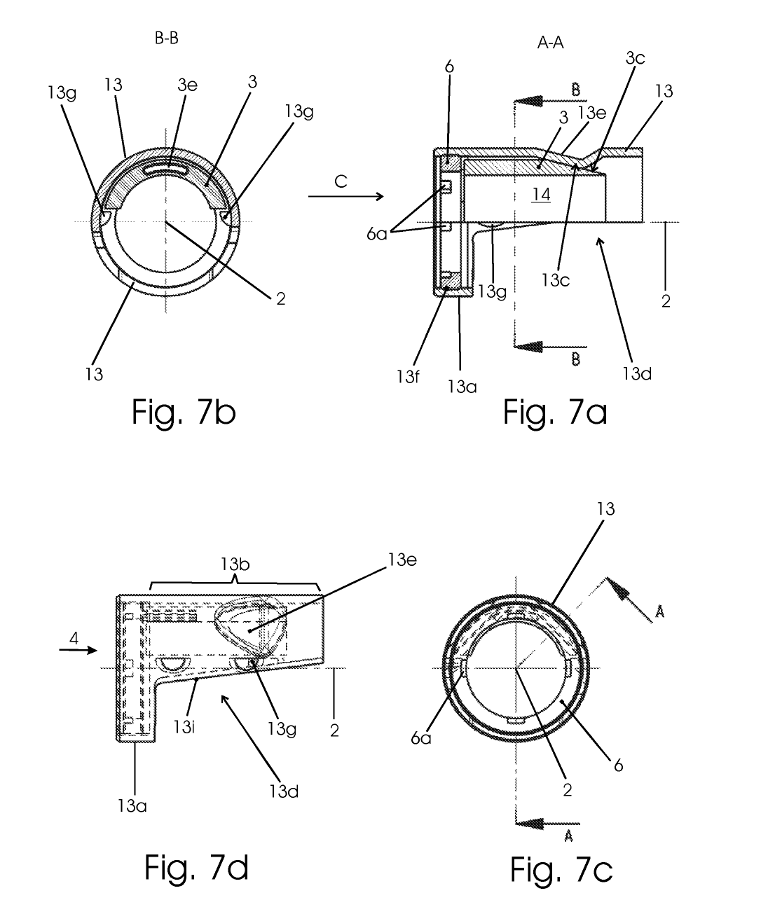

FIG. 7a the bearing module assembled from the kit parts according to FIG. 6 in a longitudinal section view along the line A-A in FIG. 7c,

FIG. 7b a section view along the line B-B in FIG. 7a,

FIG. 7c an end view according to the arrow C in FIG. 7a,

FIG. 7d a longitudinal side view of the assembled bearing module with inner contours shown in broken lines,

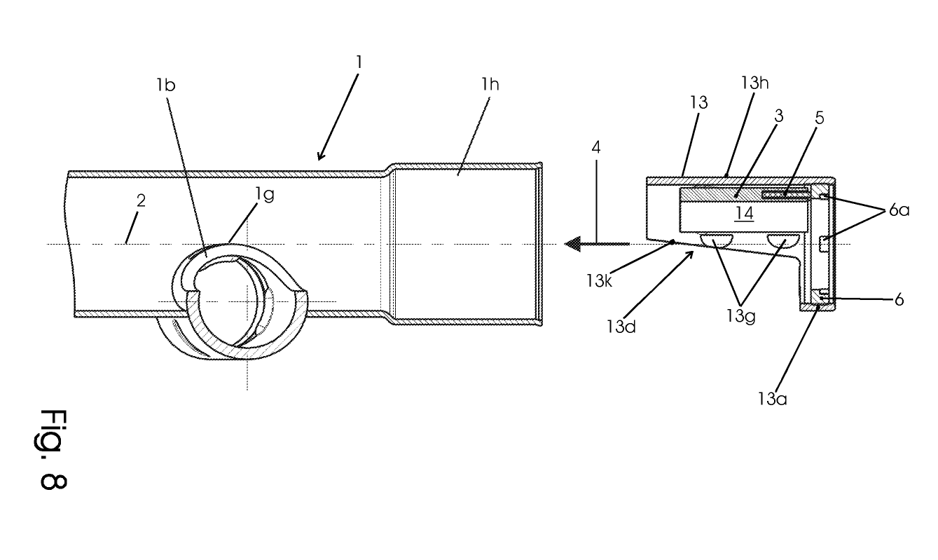

FIG. 8 in an exploded longitudinal section view a steering gear housing and the fully assembled bearing module still to be inserted into the housing,

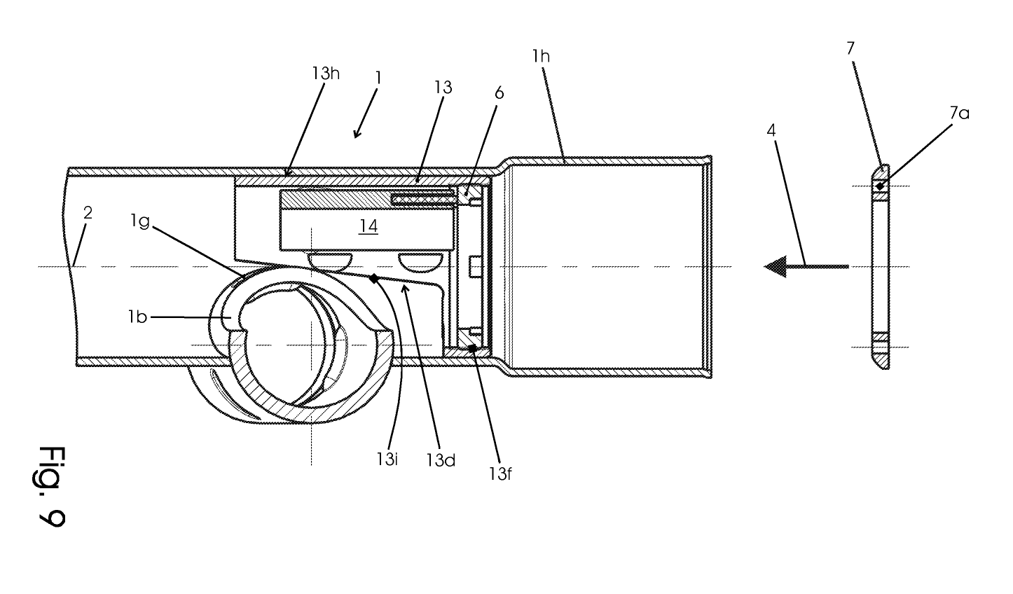

FIG. 9 a longitudinal section view of the bearing module inserted into the housing with the bearing stop ring then to be inserted,

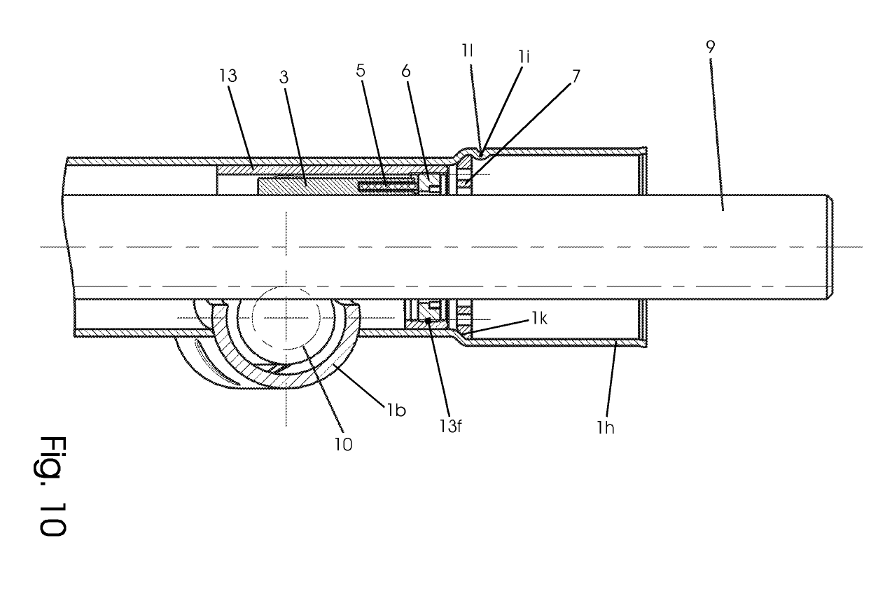

FIG. 10 a diagram of the fully assembled state in longitudinal section with rack and driving pinion,

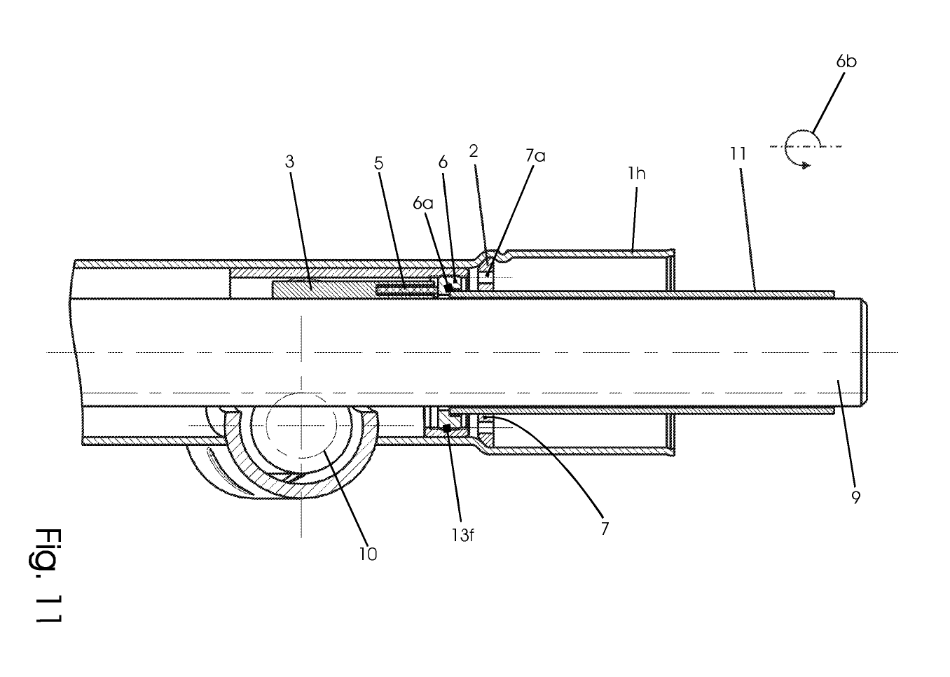

FIG. 11 the application of an adjusting tool to be rotated shown in longitudinal section,

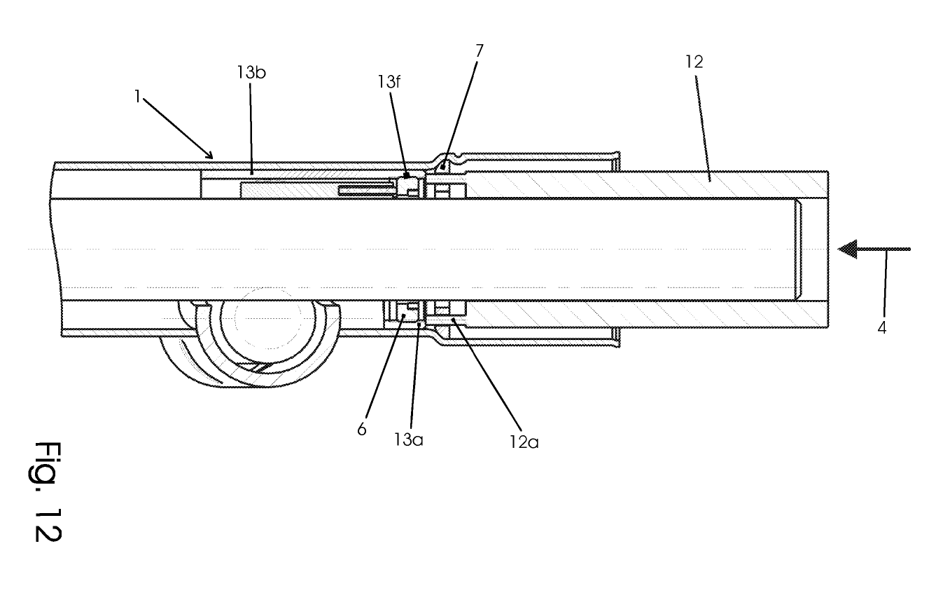

FIG. 12 the application of a caulking tool in longitudinal section,

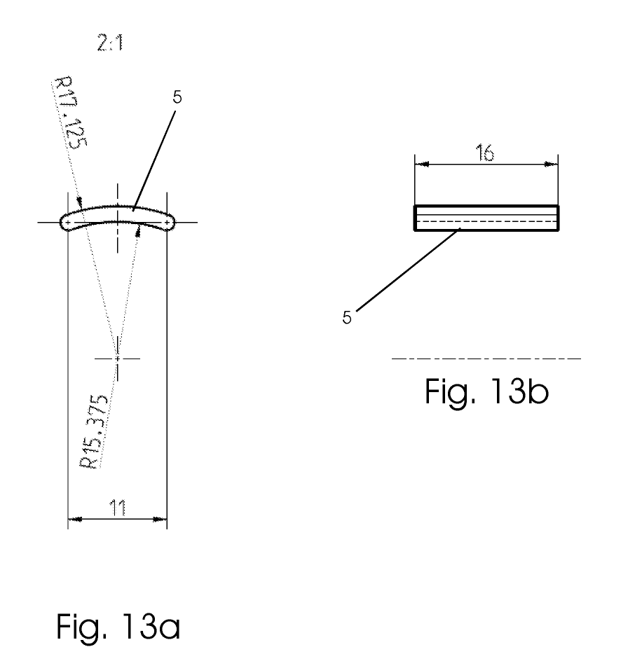

FIG. 13a an elastomer spring provided for the pressure shell in an axial end view,

FIG. 13b the same elastomer spring in a side view,

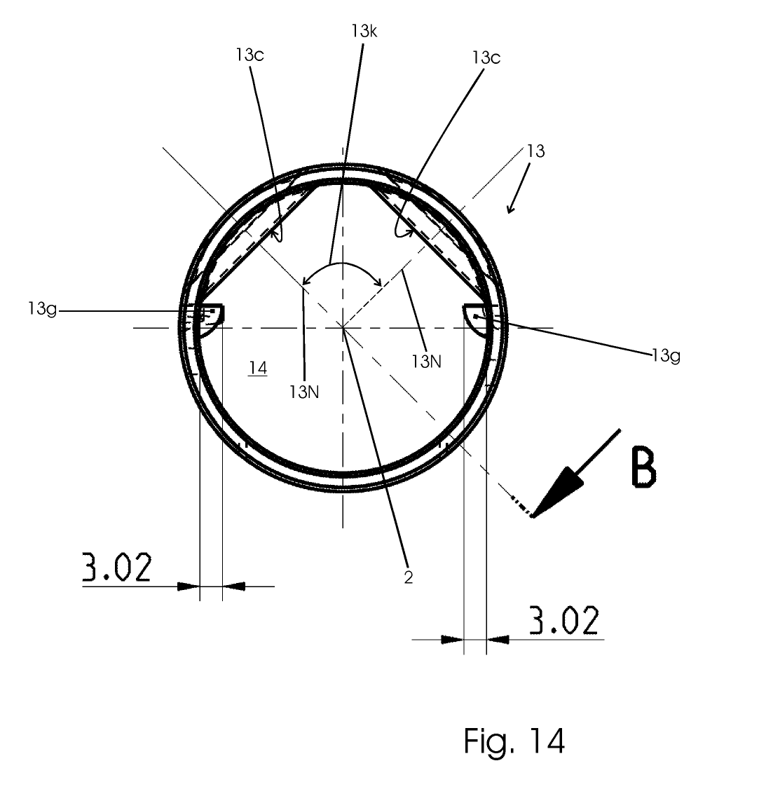

FIG. 14 an end view of the pressure ring of the second embodiment,

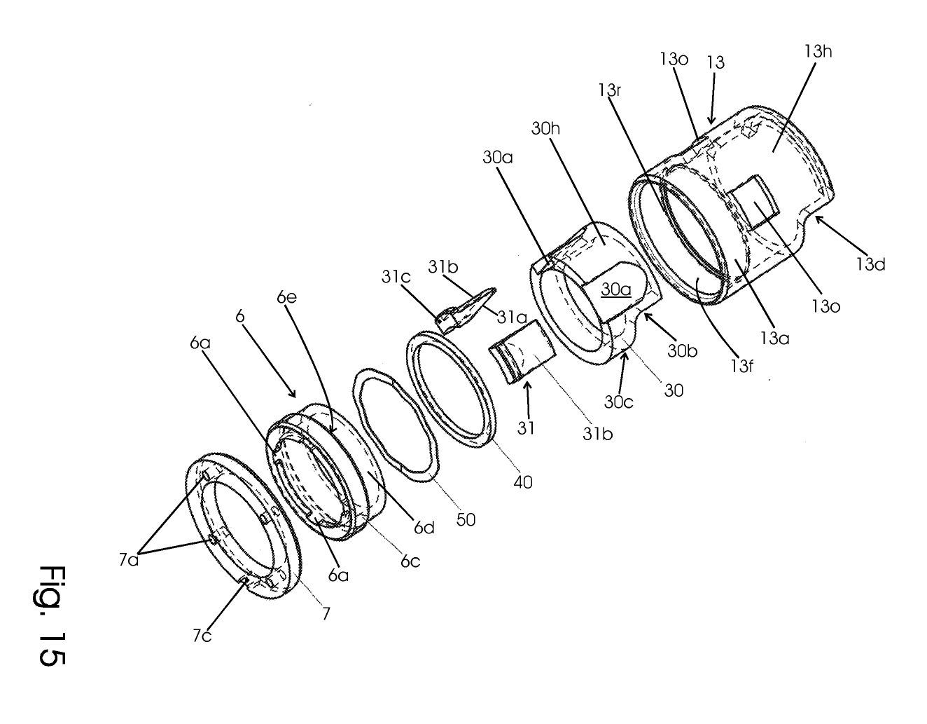

FIG. 15 an exploded, perspective diagram of a third embodiment,

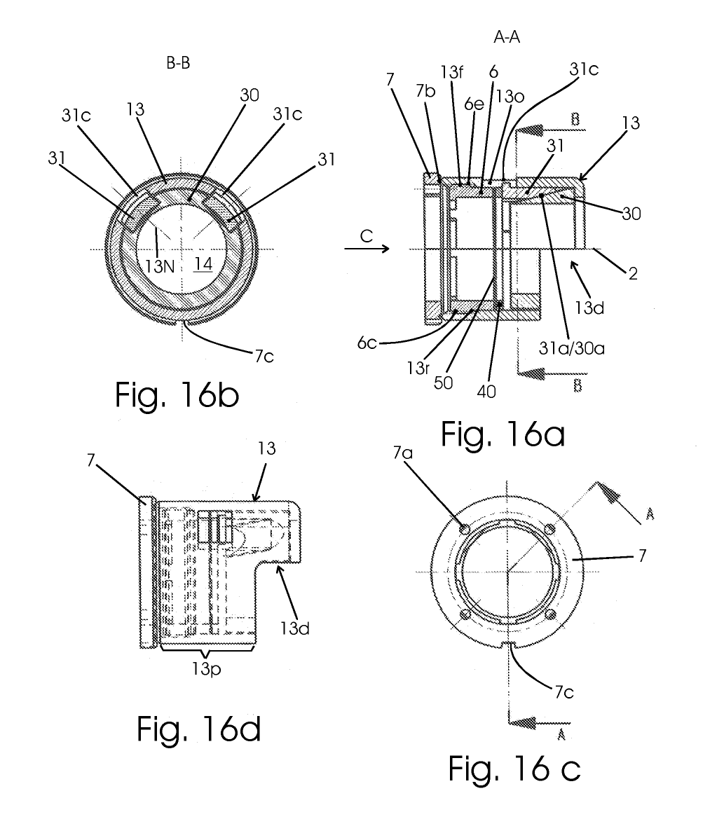

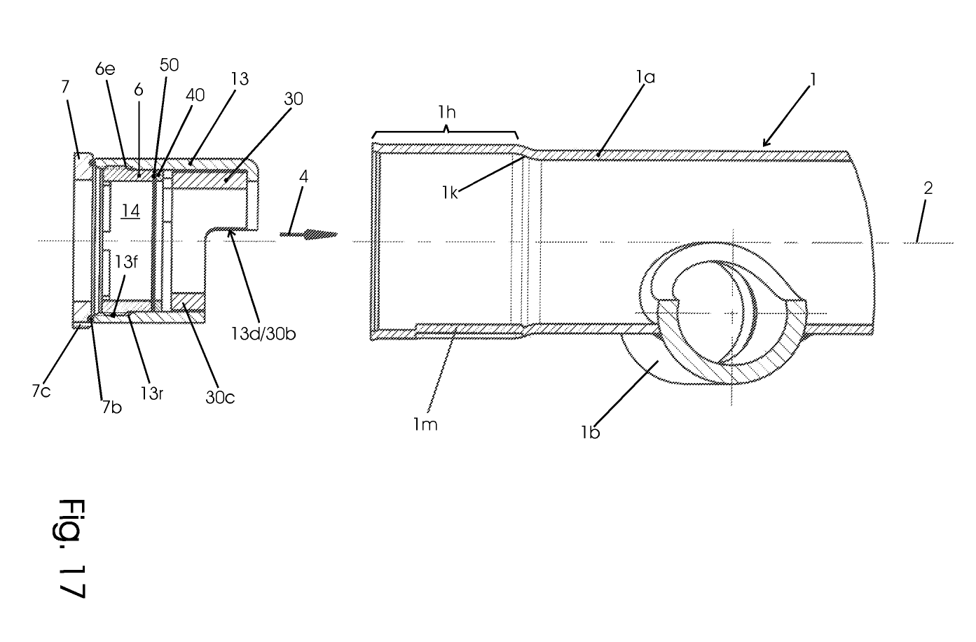

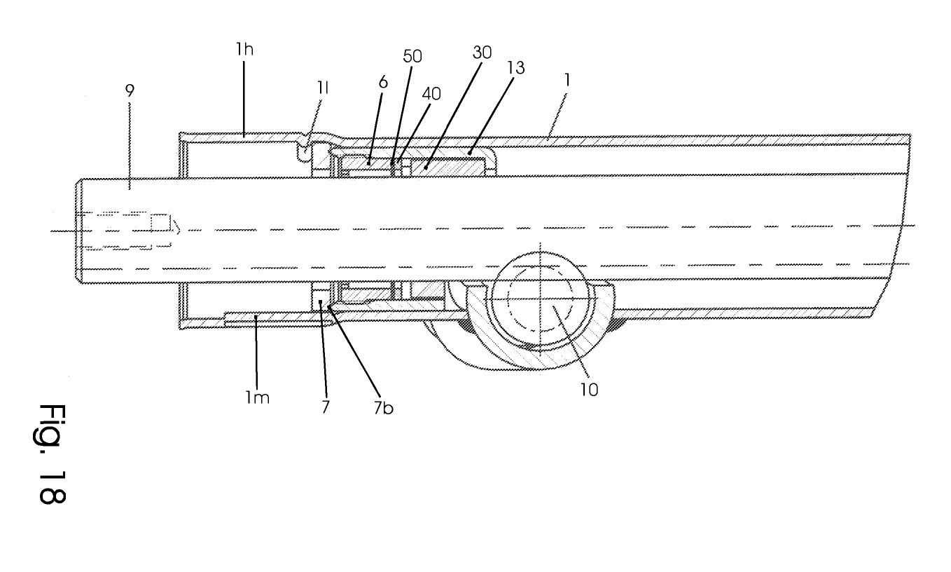

FIG. 16a the bearing module assembled from the parts of FIG. 17 in longitudinal section along the line A-A in FIG. 18c,

FIG. 16b a section view along the line B-B in FIG. 18a,

FIG. 16c an end view according to the arrow C in FIG. 18a,

FIG. 16d a longitudinal side view of the bearing module with inner contours drawn in broken lines,

FIG. 17 in an exploded longitudinal section the fully assembled bearing module before insertion into the steering gear housing,

FIG. 18 the bearing module fully assembled in the steering gear housing with rack and driving pinion, in a longitudinal section view,

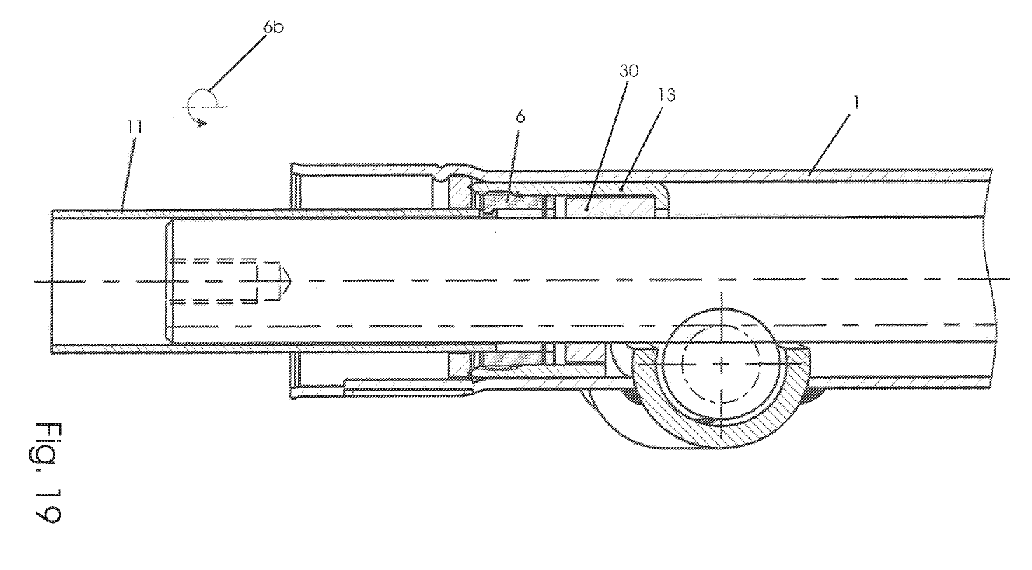

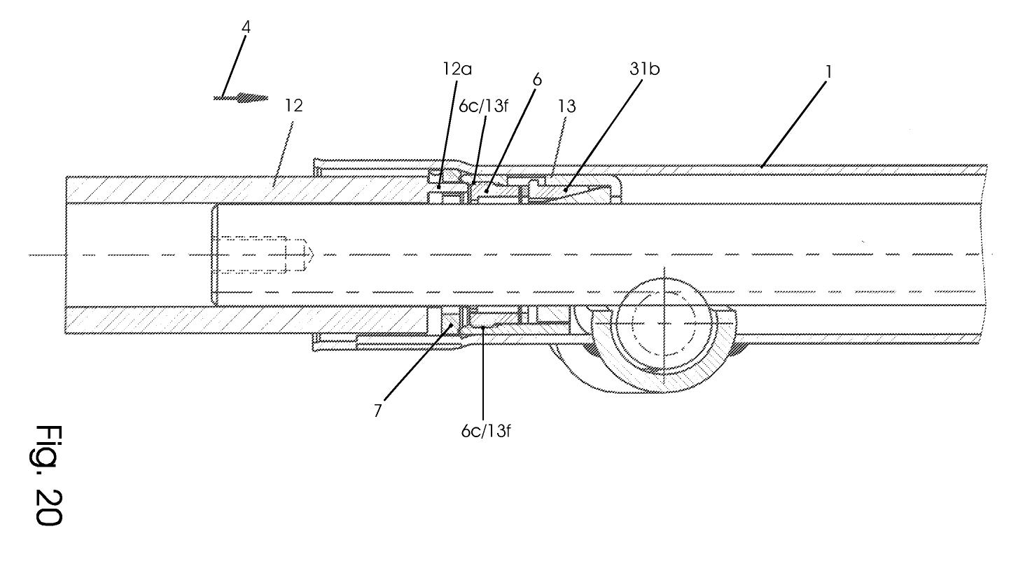

FIG. 19 a diagram corresponding to FIG. 20 with inserted adjusting tool,

FIG. 20 a diagram corresponding to FIGS. 20 and 21 with the caulking tool inserted.

According to FIG. 1, a tubular steering gear housing 1 consists of a tubular rack part 1a and a tubular pinion part 1b extending transverse or obliquely thereto. Both are joined together with respectively open longitudinal side or casing regions, so that the rack and driving pinion can mesh together. Further, the steering gear housing 1 is provided with oil lines 1c and supply terminals 1d. In the joining region between the rack part tube 1a and the pinion part tube 1b, two plane indentations 1e are recognisable on the outer casing of the rack part tube 1a and extend obliquely to the housing/rack part longitudinal axis 2 inclined to the housing interior and produce corresponding complementary oblique faces on the housing inner face to form wedge devices, as will be explained more fully below.

To press the rack against the driving pinion, a pressure member is provided in the form of a pressure shell 3. This is formed in the concrete example as a semi-cylindrical, arched casing section with a convex outer face 3a and a concavely open inner or opening face 3b. For the pressure shell 3, manufacture as a plastics injection-moulded part is advantageous. On the front end in its insertion direction 4 into the housing 1, on the convex outer face 3a two slide and abutment faces 3c are preferably formed plane, which extend like a ramp obliquely with respect to the longitudinal axis 2 or the actual cylinder longitudinal axis 2, radially inward and inclined and are allocated to the counter-slide and abutment faces, which are produced on the housing inner face by the indentations 1e in the outer casing of the housing 1. On the rear end face 3d of the pressure shell 3a receiving chamber 3e is formed, which extends into its wall interior. To receive the same therein, a resilient elastomer impact body 5 is provided. Further, in the insertion direction 4 of the pressure shell 3 with the elastomer impact body 5 a male-threaded ring 6 and a steering stop ring 7 (known as the lockstop) are disposed downstream.

As can also be seen from FIG. 2, as an insertion aid for the pressure shell 3, support means 8 in the form of pins are provided, to which receiving holes 8a are allocated, which penetrate the wall of the housing 1 in a diametrically opposed manner. On the pins or support means 8, after fixing by resistance welding for the purpose of sealing-tightness, the pressure shell may be rest and slide upon insertion 4 with its lateral opening edges 3f.

As is indicated in FIG. 2, the rack part 1a of the housing 1 has a section 1f with a female thread so formed that the male-threaded ring 6 can engage and mesh therewith.

This is shown in FIG. 3, which shows the fully assembled state of the steering gear example according to the invention. The pressure shell 3 is inserted sufficiently far into the housing 1 that its pair of slide and abutment faces 3c abut the counter-slide and abutment faces, which are formed by the indentations 1 e, as described above. At the same time, the pressure shell 3 can rest with its opening edges 3f on projecting edges 1g of the tubular pinion part. Further, according to FIG. 3, the elastomer impact body 5 is inserted into the receiving chamber of the pressure shell 3 and projects therefrom with a residual section for stopping on the male-threaded ring 6. This meshes with the female-threaded section 1f of the gear housing 1. Further, the rack 9 and the driving pinion 10 are so inserted and assembled in the rack part 1a and the pinion part 1b of the housing 1 that they mesh or engage with one another.

As can be deduced particularly from FIG. 2 and FIG. 3, the housing rack part 1a is formed with a radially expanded end region 1h, to whose inner diameter the steering stop ring 7 is adapted with its outer diameter for insertion 4 and subsequent press fit. In the fully assembled state according to FIG. 3, in order to lock the steering stop ring 7 axially, a bead 1l is so formed in the housing wall from the outside that on the inside of the rack part 1a an inner bulge 1i is formed. This engages behind the steering stop ring 7 at its rear end face. Its front end face associated with the male-threaded ring 6 abuts a stop shoulder 1k on the housing inner face, which is produced by the radial expansion 1h mentioned. According to FIGS. 1-3, the steering stop ring 7 is penetrated in an axially parallel manner by plural bores 7a, which assist the penetration of a caulking tool (see FIG. 5).

According to FIG. 4, the inner diameter of the steering stop ring 7 is such that a hollow-cylindrical adjusting tube 11 can be pushed through over the rack 9 and simultaneously through the steering stop ring 7, until end-face projections of the adjusting tube 11 can move into complementary, end-face, radially outwardly extending recesses 6a in the male-threaded ring 6 for its rotation 6b by means of the adjusting tube 11. The axis of rotation for the male-threaded ring 6 or adjusting tube 11 is the longitudinal axis 2 extending concentrically or coaxially thereto.

If according to FIG. 4 a rotation 6b is imparted to the adjusting tube 11, this is transferred to the same due to the end-face recesses 6a in the male-threaded ring 6. Thus this screws along the female thread 1f upon appropriate direction of rotation and thus presses on the elastomer impact body 5 in the pressure shell 3. The latter is thus displaced axially with spring-loaded play, and the slide and abutment faces 3c of the pressure shell 3 are increasingly pressed against the counter-stop and slide faces on the housing inner face, which are formed by the indentations 1e mentioned. The abutment and slide faces 3c and the indentations 1e together form wedge devices or wedge pushers with two complementary slopes allocated to the one another for abutment and displaceable relative to one another. By these, an axial displacement of the pressure shell 3 is converted into a radial pressure force and deflected on to the rack 9. In this case, the adjusting tube 11 can be rotated in a metered manner so that axial play of the pressure shell 3 with respect to the male-threaded ring 6 is adjustable via the elastomer impact body 5. Accordingly, a radial play is produced between the rack 9 and the driving pinion 10 of e.g. 0.05 mm, which is under a spring load of e.g. 200-300 N. The same applies to the second and third embodiments.

According to FIG. 5, in order that the male-threaded ring 6 reliably keeps its axial position after adjustment, a caulking tool 12 is used. On its front end face in the insertion direction 4, engaging projections 12a are formed and are distributed around its circumference in such a manner that they are immersed in the abovementioned axially parallel bores 7a of the steering stop ring 7 and can penetrate the same. Upon further axial displacement 4, these can be pushed beyond the state shown in FIG. 5 so far until they are in active connection with the meshing region between the male-threaded ring 6 and the housing female thread 1f. Then the caulking tool 12 is impressed e.g. by vibrating forces, so that via the engaging projections 12a the meshing male and female thread 6, 1f are caulked or otherwise deformed. Thus the male-threaded ring 6 can no longer be rotated, or is axially fixed.

In FIG. 6, a kit is shown with a pressure shell 3 (identical to the one in FIG. 1) with a receiving chamber 3e and oblique slide and abutment faces 3c at the front end. The kit includes further the elastomer impact body 5 already described above, the male-threaded ring 6 also described above and an outer pressure ring 13 acting as a pressure member with a female-threaded section 13a at the insertion end. The male-threaded ring 6 and the female-threaded section 13a are adapted to one another for meshing or engagement. As a complement to the slide and abutment faces, indentations 13e similar to the indentations 1e in the gear housing 1 according to the embodiment of FIGS. 1-5 are provided. The oblique counter-slide and abutment faces 13c produced on the inside of the pressure ring by the indentations 13e, together with the chamfered pressure-shell slide and abutment faces 3c, form wedge devices which are displaceable respectively in an axial or axially parallel manner, similarly to the embodiment according to FIGS. 1-5. If the pressure shell 3 is inserted into the interior of the pressure ring 13 in the insertion direction 4, it can rest and slide on support shoulders 13g, which are formed projecting inward from the inner wall of the pressure ring 13. They can be produced e.g. by punching of the pressure ring wall. Advantageously, according to the embodiment, plural axially consecutive pairs are provided, each with two diametrically opposite support shoulders 13g.

According to FIG. 7a, the kit with its components is assembled into a finished bearing module. The pressure shell 3 abuts with its oblique slide and abutment faces 3c the oblique counter-slide and abutment faces 13c to form a wedge device.

According to FIGS. 7a and 7d, an open shell section 13b adjoins with an open, concave longitudinal side 13d the annular female-threaded section 13a of the pressure ring 13. Its defining edges 13i extend obliquely relative to the central longitudinal axis 2 in order to permit a play-free wedge press fit upon insertion and assembly in the steering gear housing with inwardly projecting edges 1g of the pinion tubular part 1b, as is explained below with the aid of FIG. 9.

According to FIG. 8, the bearing module assembled from the parts according to FIG. 6 is to be inserted into the steering gear housing 1 in the insertion direction 4. It can be seen that the elastomer impact body 5 received in the pressure shell 3 abuts with its end face a slightly projecting part on the male-threaded ring 6. The support shoulders 13g act as temporary supports until after assembly in the steering gear housing 1 a rack is inserted into the guide passage 14 of the bearing module. The guide passage 14 is directly surrounded by the pressure shell 3 and indirectly by the outer pressure ring 13 in the second embodiment, whilst in the first embodiment according to FIGS. 1-5 the guide passage 14 is directly surrounded by the pressure shell 3 and indirectly by the gear housing 1.

According to FIG. 9, the preassembled bearing module with a virtually pistol-like basic shape is pressed into the gear housing. In this case, it is mounted over the projecting edge 1g of the pinion tubular part 1b and due to the oblique progression of the defining edges 13i relative to the longitudinal axis 2 is wedged without play with the edge 1g of the pinion tubular part 1b projecting into the housing interior. The oblique defining edges 13i lead upon increasing insertion 4 to a rising radial force on the outer pressure ring 13, so that this is pressed with its convex outer casing 13h against the housing inner face. The female-threaded section 13a closed as a ring, which makes up the rear part of the outer pressure ring 13, and meshes with the male-threaded ring 6, is clamped in a force fit in the housing 1. By the adjoining oblique defining edges 13i, the outer pressure ring is secured against rotation and is held in the correct rotational or circumferential position, so that the rack can slide to and fro in the guide passage 14.

According to FIG. 10, the steering stop ring 7 is still inserted in the radially expanded end region 1h of the gear housing 1 and is fixed axially by means of the bead 11. By way of supplement, we refer to the comments above on FIG. 3 where applicable. The same applies to FIGS. 11 and 12 with respect to FIGS. 4 and 5 respectively.

According to FIG. 13a, the elastomer impact body 5 has in the end view or in cross-section a slightly arched form with a smaller inner radius and a larger outer radius. In the longitudinal side view of FIG. 13b, it can be seen that the elastomer impact body 5 is formed plane or without curvature in the axial direction. The receiving chamber 3e of the pressure shell 3 is formed in a complementary manner to the end-face or longitudinal side profiles shown in FIGS. 13a and 13b.

According to FIG. 14, the wedge face perpendicular lines or normals 13N of the counter-slide and abutment faces 13c, which are generated by the outer indentations 13e of the outer pressure ring 13, intersect in the centre of the rack guide passage 14, i.e. in the central longitudinal axis 2 of the outer pressure ring 13. From the combination of the radial forces emitted from the wedge devices in the direction of the normals 13N with reaction forces resulting from the rack 9, for the rack 9 a statically perfect determination is produced. Since furthermore the radial forces emitted from the counter-slide and abutment faces 13c of the outer pressure ring 13 are oriented towards one another and to the centre of the guide passage 14, also the rack 9 affected by these radial forces is accordingly centred. According to the embodiment of FIG. 14, the angle of intersection 13k between the two normals 13N is about 90°.

According to FIG. 15, in the third embodiment, the kit comprises for the bearing module also independently preassembled, an outer pressure ring 13, an inner guide ring 30, two separately formed wedge members 31, an axial pressure ring 40, a corrugated washer 50, an adjusting male-threaded ring 6 and a steering stop ring 7. The outer pressure ring 13 differs from that of the second embodiment substantially in that no outer indentations, but instead two perforations 13o are formed in the convex outer casing 13h, which fully penetrate the ring wall. A further difference is that the open shell section or the open longitudinal side 13d is substantially shorter than in the second embodiment according to FIGS. 6-14, whilst the closed ring section 13p (cf. FIG. 16d) significantly extends beyond the female-threaded section 13a and is substantially longer than the shell section 13d of the outer pressure ring 13. Accordingly, the guide ring 30 is structured in the axial direction and in the insertion direction relative to the outer pressure ring 13 with a first shell section 30b and a subsequent closed annular or cylindrical section 30c. On its convex outer casing 30h, plane oblique faces 30a are formed, which extend in the outer casing as smooth, plane recesses obliquely or like a ramp towards the centre line of the close cylindrical section 30c of the inner guide pressure ring 30. The two wedge members 31 are respectively formed for insertion into the ramp oblique faces 30a, in that the wedge member width corresponds roughly to the width of the recessed oblique faces 30a. In this case, a plane wedge flank 31a comes into abutment with the oblique face 30a of the guide pressure ring 30, whilst the outer wedge flank 31b, which may be concavely arched, extends axially parallel. The two wedge members 31 are further formed with a transverse stop 31c each on the rear end opposite the outer pressure ring, which stop in the assembled state of the bearing module projects through a respective perforation 13o of the outer pressure ring 13 at the position in a recessed oblique face 30a of the inner guide pressure ring 30. Since the wedge members 31 are slidingly displaceable in the respective oblique recesses 30a in an axially parallel manner, but in the circumferential direction are fixed with positive locking and therefore immovably, they form with their transverse stops 31c penetrating the perforations 13o rotation locks for the inner guide pressure ring 30 with respect to the outer pressure ring 13. This is because in the case of an attempt at rotation, the respective transverse stop 31c of the wedge member 31 would stop in the circumferential direction on a limit of the perforation 13o; the perforation limit 13o therefore blocks circumferential movements of the wedge members 31, whereas sufficient play is available for an axial or axially parallel displacement of the transverse stops 31c in the perforations 13o in order to adjust the radial force.

In the preassembled state according to FIG. 16a, the oblique inner wedge flank 31a of the individual wedge member 31 and as counter-slide and abutment face the slope face recess 30a of the guide pressure ring 30 abut one another in a slidingly displaceable manner. Via the corrugated washer 50 and the downstream axial pressure ring 40, by rotation of the male-threaded ring 6, axial force can be exerted on the individual wedge members 31, so that by their displacement the axial force is convertible via the guide pressure ring 30 with its oblique-face recess 30a into a corresponding radial force on the rack inserted into the guide passage 14. This is shown in FIG. 19, where to this end the adjusting tube 11 is used according to the comments above. As the special spring lock washer 50 in the form of a corrugated washer does not offer a definite contact face, it is advantageous to connect downstream the axial pressure ring 40 with a plane end face.

From FIG. 15, the division of the adjusting male-threaded ring 6 into a male-threaded section 6c and a guide section 6d extending forward in the direction of the outer pressure ring 13 can be seen. These two diameter steps are defined from one another by a stop ring shoulder 6e. To the latter is allocated a counter-stop ring shoulder 13r on the inner face of the outer pressure ring 13. Thus a screw-on limit is formed for the male-threaded ring 6.

According to FIG. 16a, the outer pressure ring 13 via its female thread 13f and the male-threaded ring 6 via its male thread 6c are meshed together. The adjusting male-threaded ring 6 can thus be rotated or screwed and moved axially against the force of the corrugated washer 50 on to the wedge member 31. After concentric (pre-)assembly of the guide pressure ring 30 with individual wedge members 31 and of the axial pressure ring 40, the corrugated washer 50 and the adjusting male-threaded ring 6 inside the outer pressure ring 13, the bearing module is closed by means of the steering stop ring 7, which is added to the front end of the female-threaded section 13a of the outer pressure ring 13 by welding, e.g. capacitor discharge welding. This is illustrated by the weld point 7b.

According to FIGS. 16b and 16c, an axially parallel orientation groove 7c is formed on the outer casing of the steering stop ring 7.

The orientation groove 7c acts according to FIG. 17 by being penetrated by a complementary orientation projection 1m on the inlet inner wall of the steering gear housing 1 and thus ensuring the correct angular position upon pressing in of the preassembled bearing module. In particular, it is thereby ensured that the wedge devices formed by the individual wedge members 31 and the complementary oblique recesses 30a orient their radial forces derived from axial displacements on to the side of the rack remote from its toothed section.

According to FIG. 17, the preassembled, independently handleable bearing module, in which the steering stop ring 7 welded on at the rear in the insertion direction 4 has a larger outer diameter than the closed annular section 13p of the outer pressure ring 13, is first to be inserted into the radially expanded end region 1h of the steering gear housing 1. This is effected until according to FIG. 18 the steering stop ring 7 welded on at the rear of the outer pressure ring 13 butts against the stop shoulder 1k (cf. FIG. 17), which is formed by the radial narrowing immediately in the end region of the orientation projection 1m. After stopping of the steering stop ring 7 on the stop shoulder 1k, for axial fixing, a radial bead indentation 11 is formed to engage behind the steering stop ring 7 similarly to FIGS. 3 and 10.

According to FIG. 19, for fine adjustment of the rack play, an adjusting tube 11 and according to FIG. 20, to secure this setting, a caulking tool 12 are used precisely as is shown above with the aid of FIGS. 4 and 5 of the first embodiment and FIGS. 11 and 12 of the second embodiment. To avoid repetition, we may refer here to the comments belonging to these figures accordingly.

### LIST OF REFERENCE NUMBERS

1 steering gear housing
1a rack part tube
1b pinion tube part
1c oil line
1d supply terminal
1e outer indentations
1f female-threaded section
1g pinion tube edge
1h radially expanded end region
1i inner bulge
1k stop shoulder
1l bead
1m orientation projection
2 longitudinal axis
3 pressure shell
3a convex outer face
3b concave inner face
3c slide and abutment face
3d rear end face
3e receiving chamber
3f opening edge
4 insertion direction
5 elastomer impact body
6 adjusting male-threaded ring
6a end-face recess
6b rotation
6c male-threaded section
6d guide section
6e stop ring shoulder
7 steering stop ring
7a axially parallel bore
7b weld point
7c orientation groove
8 support means
8a receiving hole
9 rack
10 driving pinion
11 adjusting tube
12 caulking tool
12a engagement projection
13 outer pressure ring
13a female-threaded section
13b open shell section
13c counter-slide and abutment face
13d open longitudinal side
13e outer indentations
13f female thread
13g support shoulder
13h convex outer casing
13i defining edge
13k angle of intersection
13N normals to wedge faces
13o perforation
13p closed annular section
13r counter-stop shoulder
14 rack guide passage
30 inner guide pressure ring
30a oblique recess
30b shell section
30c closed cylinder section
30h convex outer casing
31 wedge member
31a inner wedge flank
31b outer wedge flank
31c transverse abutment
40 axial pressure ring
50 corrugated washer

1. Bearing module for a motor vehicle steering gear having a rack (9) and a driving pinion (10) in mesh therewith, wherein the bearing module has at least one pressure member (13) with a receiving concavity, whose concave wall surrounds a guide passage (14) for the axial guiding of the rack (9), and radial forces emitted from the wall may be generated by means of at least one translationally displaceable wedge device (3c, 13c; 30a, 31a) for pressing the rack (9) received in the guide passage (14) on to the driving pinion (10) engaging therein, characterised in that in order to generate the radial forces, the one or more wedge devices (3c, 13c; 30a, 31a) are guided displaceably in a direction (4) which extends axially or axially parallel to the guide passage (14) for the rack (9).

2. Bearing module according to claim 1, characterised in that the one or more wedge devices (3c, 13c; 30a, 31a) are disposed inside the receiving concavity of the pressure member (3; 13, 30).

3. Bearing module according to claim 1, characterised in that the one or more wedge devices (3c, 13c; 30a, 31a) are disposed or formed with an abutment or support on the wall of the pressure member (13) or its receiving concavity respectively.

4. Bearing module according to claim 1, characterised in that the guide passage (14) is directly limited by one or more separately formed guide pressure parts (3; 30), which are disposed inside the receiving concavity, are supported on the wall thereof, and may be acted on by a radially inwardly oriented force by means of the wedge device(s) (3c, 13c; 30a, 31a) which are adjustable axially or in an axially parallel manner, to which end the one or more wedge devices (3c, 13c; 30a, 31a) are guided, disposed or formed between the pressure member (13) and the guide pressure part(s) (3, 30).

5. Bearing module according to claim 1, characterised in that at least one of the wedge devices (3c, 13c; 30a, 31a) is formed with two complementary slopes (3c, 13c; 30a, 31a) allocated to one another for abutment and being displaceable relative to one another, and belonging to different module components (13, 3; 30, 31) guidable relative to one another.

6. Bearing module according to claim 5, characterised in that each one of the two slopes of a wedge device (3c, 13c) is formed on the pressure member inner wall and on an opposing wall of the respective guide pressure part (3).

7. Bearing module according to claim 6, characterised by a guide pressure part (3) with a basic shape concentric to the guide passage (14), the said part being provided on its outer casing opposite the pressure member inner wall with the one or more slopes (3c), to which complementary slopes (13c) are respectively allocated on the pressure member inner wall.

8. Bearing module according to claim 6, characterised by a guide pressure part (3) with a shell-like or part-circle-like basic shape, wherein the shell opening or concave part-circle side (3b) faces the guide passage (14).

9. Bearing module according to claim 6, characterised in that the guide pressure part (3) has the one or more slopes (3c) on an end edge or in another end region.

10. Bearing module according to claim 6, characterised in that the one or more slopes (13c) of the pressure member inner wall are formed by outer complementary indentations (13e) or other recesses in the pressure member outer casing (13h).

11. Bearing module according to claim 6, characterised in that the guide pressure part (3) is guided displaceably via one or more support means, which are formed on the pressure member inner wall or in the rack guide passage (14).

12. Bearing module according to claim 11, characterised in that as a support means plural support shoulders (13g) project from the pressure member inner wall and are disposed diametrically opposite one another, on which the guide pressure part (3) rests displaceably with end faces or edges (3f) via sliding contact.

13. Bearing module according to claim 4, characterised by at least one separately formed wedge member (31) with two wedge flanks (31a, 31b) extending at an acute angle, one of which (31b) extends or is disposed axially or axially parallel, whilst the other wedge flank (31a) forms one of the two slopes of the wedge device (30a, 31a) and is allocated to its second slope (30a) for abutment, wherein the second slope (30a) extends on an outer face, opposite the wedge member (31), of the guide pressure part (30) in a complementary manner.

14. Bearing module according to claim 13, characterised in that the or at least one of the wedge members (31) is disposed between the concave wall of the pressure member (13) and a guide pressure part (30).

15. Bearing module according to claim 14, characterised in that in order to secure the wedge member (31) against rotation, the wedge member is provided with one or more stops (31c) which project transverse or obliquely to its longitudinal direction or to the axial direction (2) and a stop being allocated to the pressure member (13) or to the guide pressure part (30) for abutment or holding in a circumferential direction concentric to the guide passage (14).

16. Bearing module according to claim 15, characterised in that the holder is formed as a recess, window, perforation (13o) or cutout in the wall of the pressure member (13) or guide pressure part (30), to which a stop (31c) is allocated for engagement.

17. Bearing module according to claim 15, characterised by an actuator (6) which is arranged for axial or axially parallel displacement of the one or more wedge devices (3c, 13c; 30a, 31a) and which is movably guided or lockable or fixable relative to the pressure member.

18. Bearing module according to claim 17, characterised in that the pressure member (13) and the actuator (6) respectively have an annular, cylindrical or other rotationally symmetrical basic shape for concentric arrangement one in another and have complementary thread devices (13f), via which the pressure member (13) and the actuator (6) may be brought into engagement rotatably and displaceably relative to one another.

19. Bearing module according to claim 18, characterised in that the meshing complementary thread devices (13f, 6) are caulked together, cold-formed or otherwise deformed in order to secure against rotation.

20. Bearing module according to claim 18, characterised by the arrangement of a spring element (5; 50) for biasing a wedge device (3c, 13c; 30a, 31a) in an axial or axially parallel direction.

21. Bearing module according to claim 20, characterised in that the respective spring element (5; 50) is supported against the actuator (6) on the one side and against one (3c; 31a) of two oblique elements of a wedge device (3c, 13c; 30a, 31a) which are adjustable relative to one another on the other side.

22. Bearing module according to claim 20, characterised in that the spring element (50) has an annular or other rotationally symmetrical basic shape optionally with corrugations or other recesses or projections projecting axially parallel from the annular base plane.

23. Bearing module according to claim 22, characterised in that between the annular spring element (50) and the wedge device (30a, 31a) a fixed, substantially plane axial pressure ring (40) is disposed.

24. Bearing module according to claim 20, characterised in that the spring element (5) is disposed in a receiving chamber (3e) and optionally projecting therefrom with one part, wherein the receiving chamber (3e) is structurally incorporated in a guide pressure part (3).

25. Bearing module according to claim 24, characterised in that the spring element (5) has a basic shape complementary to the receiving chamber (3e) or elastomer or resilient material.

26. Bearing module according to claim 20, characterised in that the outer casing of the pressure member or of a steering stop ring (7) added to the end-face thereof is provided with one or more orientation projections or recesses (7c), which are allocated to complementary recesses (1m) or projections on the inner face of a hypothetical steering gear housing (1) and are so positioned in the circumferential direction that upon hypothetical assembly with the rack (9) and the driving pinion (10) in the steering gear housing (1), the radial forces emitted from the concave wall are oriented to the rack outer face or the rack outer casing section which diametrically oppose, optionally with axial offset, its teeth meshing with the driving pinion (10).

27. Bearing module according to claim 20, wherein the receiving concavity of the pressure member (13) is provided at least in part with a longitudinal side opening (3b, 3f; 13d; 30b) parallel to the axis (2) of the guide passage (14), characterised in that the longitudinal side edges (13i) defining the opening (13d) extend obliquely in a ramp-or wedge-like manner with respect to the axis (2) or a longitudinal plane of the guide passage (14) or of a hypothetical steering gear housing (1).

28. Bearing module according to claim 20, characterised by plural wedge devices (3c, 13c; 30a, 31a) with an arrangement relative to one another such that their respectively mutually abutting slopes (3c, 13c; 30a, 31a) have normals (13N) which intersect in the centre (2) of the guide passage (14) and/or at an angle (13k) of less than 180°.

29. Bearing module according to claim 20, characterised by two wedge devices (3c, 13c; 30a, 31a) each with mutually abutting slopes, whose normals (13N) converge towards the centre (2) of the guide passage (14).

30. Motor vehicle steering gear, in which within a gear housing (1) a rack (9) is engaged with a driving pinion (10), having a bearing module mounted therein, the bearing module having a rack (9) and a driving pinion (10) in mesh therewith, wherein the bearing module has at least one pressure member (13) with a receiving concavity, whose concave wall surrounds a guide passage (14) for the axial guiding of the rack (9), and radial forces emitted from the wall may be generated by means of at least one translationally displaceable wedge device (3c, 13c; 30a, 31a) for pressing the rack (9) received in the guide passage (14) on to the driving pinion (10) engaging therein, the bearing module being characterised in that in order to generate the radial forces, the one or more wedge devices (3c, 13c; 30a, 31a) are guided displaceably in a direction (4) which extends axially or axially parallel to the guide passage (14) for the rack (9), the rack (9) being pressed against the pinion (10) by the bearing module, the steering gear being characterised by an actuator (6) disposed in the bearing module and formed in such a manner that an adjusting tool (11) may be brought into mesh therewith by axial insertion in the housing (1) in order to actuate the actuator (6), the actuator (11) being in active connection with the wedge device(s) (1e, 3c; 3c, 13c; 30a, 31a) for axial or axially parallel displacement thereof.

31. Steering gear according to claim 30, having a bearing module according to claim 27, characterised in that inside the housing (1) support edges, shoulders or abutments are formed, which are allocated to the oblique open longitudinal sides (13i) of the receiving concavity, in order following its axial insertion (4) to bend or wedge and hence position fixedly the bearing module in the housing.

32. Steering gear according to claim 31, wherein the gear housing (1) has for the driving pinion (10) a pinion tubular part (1b) which extends obliquely or transverse to the main longitudinal axis, characterised in that the pinion tubular part (1b) is formed with edges (1g) projecting into the interior of the housing (1), with which the bearing module may be wedged with its oblique longitudinal side edges (13i).

33. Motor-vehicle steering gear, in which within a gear housing (1) a rack (9) is in engagement with a driving pinion (10), and having at least one pressure member (3) with a receiving concavity, whose concave wall surrounds a guide passage (14) for axial guiding of the rack (9), wherein radial forces emitted from the wall may be generated by means of at least one translationally displaceable wedge device (1e, 3c; 3c, 13c; 30a, 31a) for pressing the rack (9) received in the guide passage (14) on to the driving pinion (10) engaging therein, characterised in that for generating radial force the one or more wedge devices (1e, 3c; 3c, 13c; 30a, 31a) are displaceably guided in a direction which extends axially or axially parallel to the guide passage (14) for the rack (9) and/or to the housing longitudinal axis (2).

34. Steering gear according to claim 33, characterised by a pressure member (3) with shell-like or partially cylindrical basic shape, wherein the shell opening (3b) or concave open partial cylinder face (3b) faces the guide passage (14).

35. Steering gear according to claim 33, wherein at least one of the wedge devices (1e, 3c; 3c, 13c; 30a, 31a) is formed with two complementary slopes which are allocated to one another for abutment and which are displaceable relative to one another, characterised in that the one slope (3c) is formed on an outer face or outer casing of the pressure member (3) and the other slope is formed on an opposing inner face or opposing inner casing of the housing (1).

36. Steering gear according to claim 35, characterised in that the pressure member (3) has one or more slopes (3c) on an end edge or in another end region.

37. Steering gear according to claim 33, characterised in that the pressure member (3) is displaceably guided on one or more support means (8) which project from the housing inner wall.

38. Steering gear according to claim 37, characterised in that the one or more support means (8) are formed by respective pins, which penetrate the housing wall from the outside.

39. Steering gear according to claim 26, characterised in that the housing inner wall has in the end-face end region one or more recesses or projections (1m) complementary to the one or more orientation projections or recesses (7c) of the pressure member outer casing or of a steering stop ring (7) connected to the end-face thereof with a positioning in the circumferential direction such that in the case of orientation projections or recesses (1m, 7c) interlocking on both sides the pressure forces emitted form the concave wall are oriented on to the rack outer face or rack outer casing section which diametrically opposes the teeth of the rack (9) meshing with the driving pinion (10).

40. Steering gear according to claim 39, characterised by an actuator (6) which is provided for axial or axially parallel displacement of the one or more wedge devices (1e, 3c; 3c, 13c; 30a, 31a) and which is movably guided relative to the gear housing (1).

41. Steering gear according to claim 40, characterised in that the housing (1) and the actuator (6) respectively have an annular, cylindrical or otherwise rotationally symmetrical basic shape for concentric arrangement one in another and have complementary thread devices (1f), via which the housing (1) and the actuator (6) may be brought into engagement rotatably and displaceably relative to one another.

42. Steering gear according to claim 41, characterised in that the meshing complementary thread devices (6, 1f) are caulked together, cold-formed or otherwise deformed to secure against rotation.

43. Steering gear according to claim 40, characterised in that one or more spring elements (5; 50) are interposed between the actuator (6) and the wedge device (1e, 3c; 3c, 13c; 30a, 31a) in order to bias the same in the axial or axially parallel direction.

44. Steering gear according to claim 43, wherein at least one of the wedge devices (1e, 3c; 3c, 13c; 30a, 31a) is formed with two complementary slopes allocated to one another for abutment and displaceable relative to one another, characterised in that the respective spring element (5; 50) is supported against the actuator (6) on the one side and against one of the two mutually relatively displaceable oblique elements of the wedge device (1e, 3c; 3c, 13c; 30a, 31a) on the other side.

45. Steering gear according to claim 44, characterised by a locking device fixing the bearing module and/or the pressure member (3; 13) or the actuator (6) in the gear housing (1) in the axial or axially parallel direction (2, 4).

46. Steering gear according to claim 45, characterised in that the locking device is formed with a stop block (7) axially inserted in the gear housing and with a radial bead indentation (11) or other deformation in the housing wall for engaging behind the stop block (7).

47. Steering gear according to claim 45, characterised by plural wedge devices (1e, 3c; 3c, 13c; 30a, 31a) with an arrangement relative to one another such that their respectively abutting slopes (3c, 13c) have normals (13N) which intersect at the centre (2) of the guide passage (14) and/or at an angle (13k) of less than 180°.

48. Steering gear according to claim 45, characterised by two wedge devices (1e, 3c; 3c, 13c; 30a, 31a), each with mutually abutting slopes (3c, 13c) whose normals (13N) converge towards the centre (2) of the guide passage (14).

49. Pressure shell (3) as a guide pressure part for a bearing module according to claim 4, characterised by a casing section which is guided over a partial circle, is partially cylindrical or otherwise curved or arched, having a convex outer face (3a) and a concave inner face or open side (3b), wherein at least one (3a) of the sides has one or more slide and abutment faces (3c), which extend obliquely in a ramp-like manner to a cylinder longitudinal axis (2) or to a longitudinal direction of the concave open side.

50. Pressure shell according to claim 49, characterised in that on an end face remote from the oblique faces at least one receiving chamber (3e) is formed, which extends into the shell wall.

51. Pressure shell according to claim 50, characterised in that in the receiving chamber (3e) an elastomer or resilient impact body (5) is received.

52. Pressure shell according to claim 50, characterised by plural oblique slide and abutment faces (3c) with an arrangement relative to one another such that their respective normals (13N) intersect at an angle of less than 180°.

53. Pressure shell according to claim 50, characterised by two oblique slide and abutment faces (13c), whose normals (13N) extend convergently.

54. A steering gear according to claim 33, characterised by one or more slopes (1e) formed on the housing inner face, which are disposed for pressing on the meshing region between the driving pinion (10) and the rack (9) and which rise or fall relative to an axially parallel direction (2, 4).

55. A steering gear according to claim 54, characterised in that the one or more slopes of the concave housing inner wall are formed by external complementary indentations (1e) or other recesses in the housing outer casing.

56. A steering gear A steering gear according to claim 54, characterised in that the plural slopes are so arranged relative to one another that their respective normals intersect in the centre (2) of a guide passage (14) for the rack (9) or at an angle of less than 180°.

57. A steering gear A steering gear according to claim 54, characterised by two slopes (1e), whose normals converge towards the centre (2) of the guide passage (14).
